(19) United States
(12) Patent Application Publication
(10) Pub. No.: US 2005/0067802 A1
(43) Pub. Date: Mar. 31, 2005

(54) Temporary shelter

(76) Inventor: Geoffrey Lambert, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/952,997

(22) Filed: Sep. 29, 2004

(30) Foreign Application Priority Data
Sep. 29, 2003 (CA) 2,443,254

(51) Int. Cl. B62B 3/00

(52) U.S. Cl. 280/47.35

(57) ABSTRACT

A temporary shelter includes a rectangular base with underlying wheels and four peripheral edges. A tubular enclosure with a longitudinal axis and radial support legs. The tubular enclosure is pivotally mounted to one of the edges of the base for pivotal movement between a first position and a second position. In the first position, the longitudinal axis is in a substantially vertical collection orientation with the tubular enclosure resting upon the base. In the second position, the longitudinal axis is in a substantially horizontal sleeping orientation with the tubular enclosure resting upon the support legs adjacent to the base. A peripheral wall extends upwardly from three of the edges enclosing all but the one edge of the base where the tubular enclosure is mounted. A cover is provided which is adapted to overlie the peripheral walls. A closure is provided which is adapted to close a remote end of the tubular enclosure when in the second position.

### FIELD OF THE INVENTION

The present invention relates to a temporary shelter and, in particular, a temporary shelter developed for use by homeless persons.

### BACKGROUND OF THE INVENTION

In some jurisdictions, bottle recycling programs are required by law. In those areas, homeless persons earn money to feed themselves by collecting bottles and taking them to bottle return depots for cash refunds. The homeless persons are still faced with a problem as to where to sleep at night.

### SUMMARY OF THE INVENTION

What is required is a temporary shelter suitable for use by homeless persons.

According to the present invention there is provided a temporary shelter, including a rectangular base with underlying wheels and four peripheral edges. A tubular enclosure with a longitudinal axis and radial support legs. The tubular enclosure is pivotally mounted to one of the edges of the base for pivotal movement between a first position and a second position. In the first position, the longitudinal axis is in a substantially vertical collection orientation with the tubular enclosure resting upon the base. In the second position, the longitudinal axis is in a substantially horizontal sleeping orientation with the tubular enclosure resting upon the support legs adjacent to the base. A peripheral wall extends upwardly from three of the edges enclosing all but the one edge of the base where the tubular enclosure is mounted. A cover is provided which is adapted to overlie the peripheral walls. A closure is provided which is adapted to close a remote end of the tubular enclosure when in the second position.

The temporary shelter, as described above, is used to collect bottles when the tubular enclosure is in the first position and is used to sleep when in the second position.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view of a temporary shelter constructed in accordance with the teachings of the present invention, with tubular enclosure in the first position.

FIG. 2 is a side elevation view of the temporary shelter illustrated in FIG. 1, with tubular enclosure in the process of being moved from the first position to the second position.

FIG. 3 is a perspective view of the temporary shelter illustrated in FIG. 1, with tubular enclosure in the second position.

FIG. 4 is an end plan view of the temporary shelter illustrated in FIG. 1.

### DETAILED DESCRIPTION OF THE PREFERRED EMBODIMENT

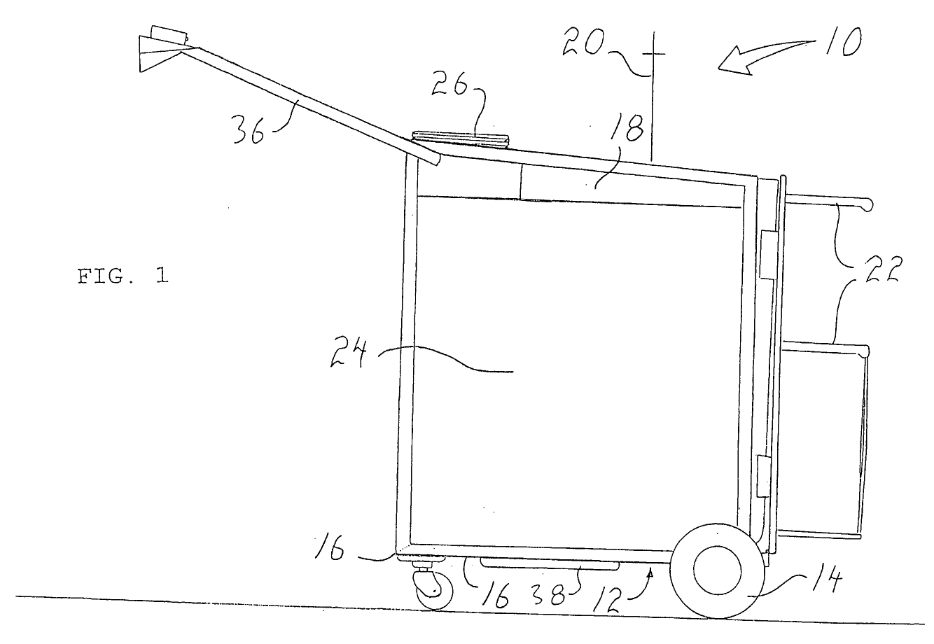

The preferred embodiment, a temporary shelter generally identified by reference numeral 10, will now be described with reference to FIGS. 1 through 4.

Structure and Relationship of Parts:

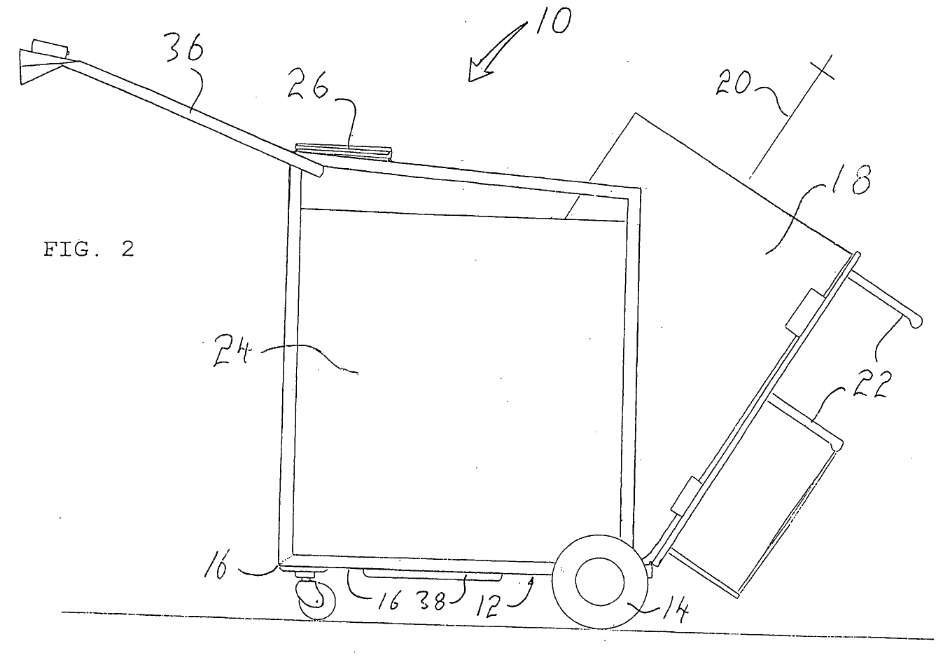

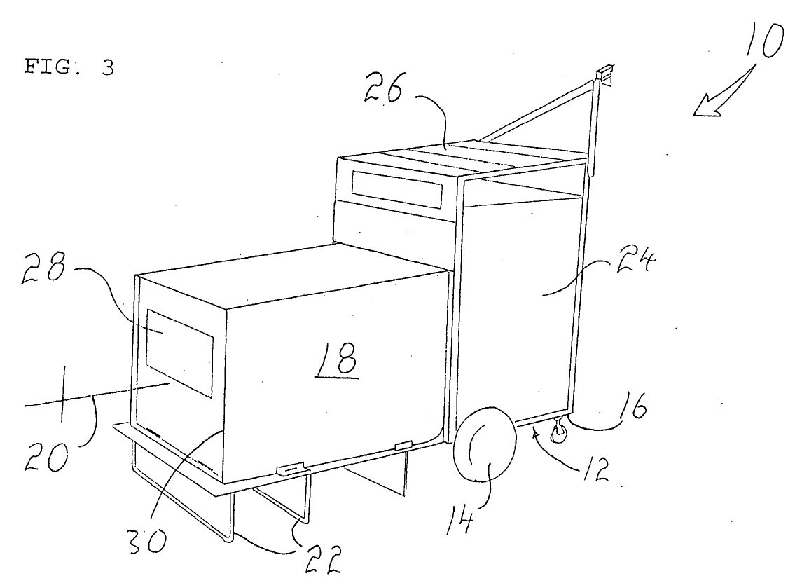

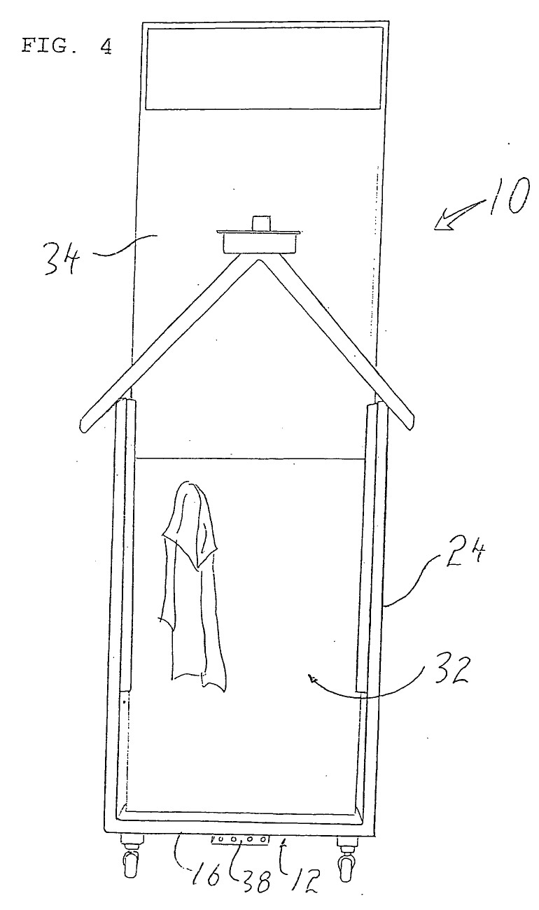

Referring to FIG. 1, shelter 10 has a rectangular base 12 with underlying wheels 14 and four peripheral edges 16. A tubular enclosure 18 with a longitudinal axis 20 and radial support legs 22 is pivotally mounted to one of edges 16 of base 12. Pivotal movement occurs between a first position (illustrated in FIG. 1) in which longitudinal axis 20 is in a substantially vertical collection orientation with tubular enclosure 18 resting upon base 12 and a second position (illustrated in FIG. 3) in which longitudinal axis 20 is in a substantially horizontal sleeping orientation with tubular enclosure 18 resting upon support legs 22 adjacent to base 12. Referring to FIG. 1, base 12 is further adapted with a peripheral wall 24 which extends upwardly from three of edges 16 enclosing all but one edge 16 of base 12 where tubular enclosure 18 is mounted. Referring to FIG. 3, base 12 has a cover 26, adapted to overlie peripheral wall 24. In the illustrated embodiment, cover 26 may be retractable as shown in FIG. 2. Referring to FIG. 3, tubular enclosure 18 has a closure 28, adapted to close a remote end 30 of tubular enclosure 18 when in second position. In the illustrated embodiment, closure 28 is hinged. Referring to FIG. 4, shelter 10 has a storage closet 32 with a sliding closure 34 built into peripheral wall 24. Referring to FIG. 2, shelter 10 is further adapted with a camera support 36, which extends above peripheral wall 24, and a built in global positioning locator system 38.

Operation:

The use and operation of temporary shelter 10 will now be described with reference to FIGS. 1 through 4. It is anticipated that a homeless person will be provided with shelter 10 and invited to collect bottles in an assigned neighbourhood. Referring to FIG. 1, tubular enclosure 18 is oriented substantially vertically in a first position and cover 26 is retracted so as to allow collection of items and the free movement of shelter 10 on wheels 14. In the illustrated embodiment, legs 22 may also function as handles or supports for bags. In order to discourage the homeless person from illegal activities and also monitor activities within the neighbourhood, camera support 36 may support a video camera. The video camera enables the activities of the homeless person to be monitored from a central location. In addition, global positioning system 38 may also operate unobtrusively. Global positioning system 38 serves to track movements within the assigned neighbourhood and also provides a means of recovering shelter 10, if it should become abandoned at an unknown location by the homeless person. Referring to FIG. 2, where a sleeping mode is desired, the homeless person may tilt longitudinal axis 20 and pivot enclosure 18 out from between walls 24. Referring to FIG. 3, once fully extended, closure 28 may close remote end 30 of enclosure 18 and cover 26 may be extended to cover walls 24. Referring to FIG. 4, a user may lift sliding closure 34 to store clothing and other belongings in storage closet 32.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

1. A temporary shelter, comprising:
a rectangular base with underlying wheels, the base having four peripheral edges;
a tubular enclosure with a longitudinal axis and radial support legs, the tubular enclosure being pivotally mounted to one of the edges of the base for pivotal movement between a first position in which the longitudinal axis is in a substantially vertical collection orientation with the tubular enclosure resting upon the base and a second position in which the longitudinal axis is in a substantially horizontal sleeping orientation with the tubular enclosure resting upon the support legs adjacent to the base;
a peripheral wall extending upwardly from three of the edges enclosing all but the one edge of the base where the tubular enclosure is mounted;
a cover adapted to overlie the peripheral walls; and
a closure adapted to close a remote end of the tubular enclosure when in the second position.

2. The temporary shelter as defined in claim 1, wherein a storage closet with a sliding closure is built into the peripheral wall.

3. The temporary shelter as defined in claim 1, wherein a camera support is mounted to and extends above the peripheral wall.

4. The temporary shelter as defined in claim 1, wherein a global positioning locator system is built in.
